(19) United States
(12) Patent Application Publication
(10) Pub. No.: US 2022/0066745 A1
(43) Pub. Date: Mar. 3, 2022

(54) CODE GENERATING SOFTWARE AND SYSTEMS FOR SOFTWARE APPLICATIONS

(71) Applicant: MAXELIT, LLC., Boca Raton, FL (US)

(72) Inventor: Raul A. DE JESUS, Boca Raton, FL (US)

(73) Assignee: MAXELIT, LLC., Boca Raton, FL (US)

(21) Appl. No.: 17/001,747

(22) Filed: Aug. 25, 2020

(51) Int. Cl. G06F 8/30; G06F 9/451; G06Q 10/10; G06Q 20/08; G06F 16/242; G06F 16/22; H04W 4/14

(52) U.S. Cl. CPC G06F 8/315; G06F 9/453; G06Q 10/103; H04W 4/14; G06Q 20/085; G06F 16/242; G06F 16/22; G06Q 10/107

(57) ABSTRACT

A system and associated computer executable code generating software to generate web applications, mobile applications, and application programming interface applications.

### BACKGROUND OF THE INVENTION

### 1. Field of the Invention

The present invention relates to computer systems with code generating programs, and more particularly, to systems and associated computer executable code generating software to generate web, mobile, and application programming interface applications.

### 2. Description of the Related Art

Most code generators require users to have certain technical levels to generate an application such as connecting to databases or application programming interfaces (APIs). In addition, most code generators only focus in one, or web apps, but none of them generate mobile applications (apps) nor APIs.

Applicant is not aware of any systems and associated computer executable code generating software that can generate cross-platform mobile apps for forms such as “XAMARIN FORMS” or open-source mobile application frameworks such as “REACT NATIVE”. Applicant is also not aware of any systems and associated computer executable code generating software having the novel features of the present invention.

### SUMMARY OF THE INVENTION

The present invention is a system and associated computer executable code generating software comprising a processor functionally associated with a digital memory, the digital memory stores processor executable code adapted to cause one or more processors to analyze code instructions of a Wizard to automatically generate web applications, mobile applications, and application programming interface applications.

A user interacts with the Wizard to gather information and the Wizard is a piece of software that conducts a conversation via auditory or textual methods via and/or with a computer comprising a processor functionally associated with a digital memory.

The executable code generates an application project. The executable code generates the web applications, the mobile applications, and the application programming interface applications in different languages, and generates databases and queries in different technologies, whereby the Wizard interacts with a given user to gather information about a type of the application project that the user wants to develop in order to generate it.

The user views and reads instructions and questions in a desired language that is provided through the Wizard. The user enters a mobile number in order to get an SMS code to validate it, whereby the SMS code is obtained with a computer such as a smart phone. Once the SMS code is validated, the user is prompted and starts to answer several questions, which the code utilizes to gather characteristics of the application project.

The Wizard asks the user about each required entity's fields or properties, and their length, and the user enters the entity's properties such as their names and data types, and connects to a backend Application Programing Interphase.

The Wizard keeps asking if the user has finished or not during the process of creating business entities, the fields and the properties, and the business entities are posted to the backend Application Programing Interphase, which is stored on the database.

The code generation is achieved by reading the entities stored in the database and writing programming language files into a preexisting Application Programing Interphase project. The code generation is achieved by reading the entities stored in the database and writing Html or Xml files into preexisting project templates, and when a file is opened for reading or writing, it becomes a stream, the stream is a sequence of bytes passing through the communication path.

Once the user chooses a type of the application project to generate, the web application, the mobile application, or the application programming interface application, it will be copied from the templates. The templates comprise all necessary files to be compiled and run from an integrated development environment. The templates are modified to include managing the business entities selected. The templates also have navigation capabilities to allow the users to choose which of the business entities they want to work with.

The system and associated computer executable code generating software generates cross-platform mobile applications built on a cross-platform mobile app development framework language as a base for app development. The system and associated computer executable code generating software generates the cross-platform mobile applications build on the cross-platform mobile app development framework using a codebase of an object-oriented computer programming language.

Once the entities are entered, the user choses to execute automaton projector process. The user is notified to make payment according the lines of code generated. When the payment is made, the user receives an email having a link with the application project generated, which is the web application, the mobile application, or the application programming interface application.

Data entry form fields are validated when the user had specified the fields or the properties as required. The database code generation is achieved by reading the entities in a database and writing script files to disk. The files are later run by the user to create it in a database server.

It is therefore one of the main objects of the present invention to provide systems and associated computer executable code generating software for the development of software applications.

It is another object of this invention to provide systems and associated computer executable code generating software for the development of a software application as a final product for a user.

It is another object of this invention to provide systems and associated computer executable code generating software to generate web applications.

It is another object of this invention to provide systems and associated computer executable code generating software to generate mobile applications.

It is another object of this invention to provide systems and associated computer executable code generating software to generate API applications.

It is another object of this invention to provide systems and associated computer executable code generating software to generate web, mobile, and API applications in different languages.

It is another object of this invention to provide systems and associated computer executable code generating software that generates databases and queries in different technologies.

It is another object of this invention to provide systems and associated computer executable code generating software, which do not require a user to have programing knowledge to use it.

It is another object of this invention to provide systems and associated computer executable code generating software that involves an intelligent user interface in an application for code generation.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a diagram of the present invention.

FIG. 2 is a flow chart of the present invention.

FIG. 3 is a flow chart of a projector process.

FIG. 4 is a first diagram that represents the algorithms of present invention.

FIG. 5 represent a relational database of the present invention.

### DETAILED DESCRIPTION OF THE PREFERRED EMBODIMENT

Referring now to the drawings, the present invention is a system and associated computer executable code generating software to generate web applications 152, mobile applications 154, and application programming interface applications 156, and is generally referred to with numeral 10. It can be observed that it basically includes Wizard 30 as an intelligent user interface, and application project 150.

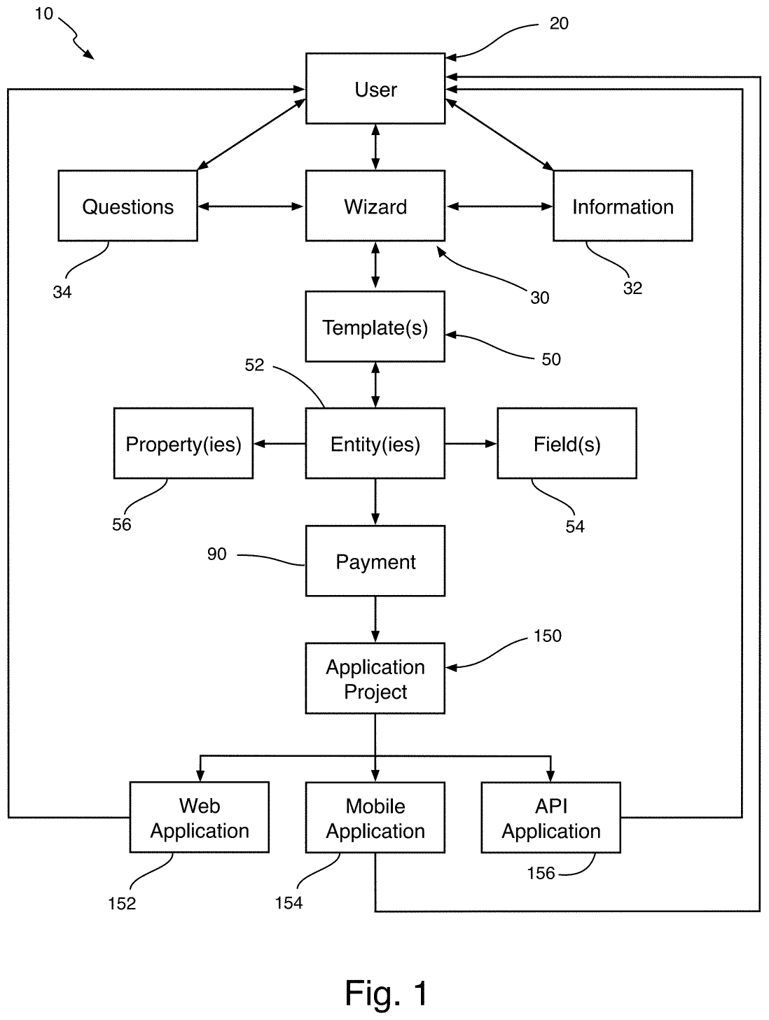

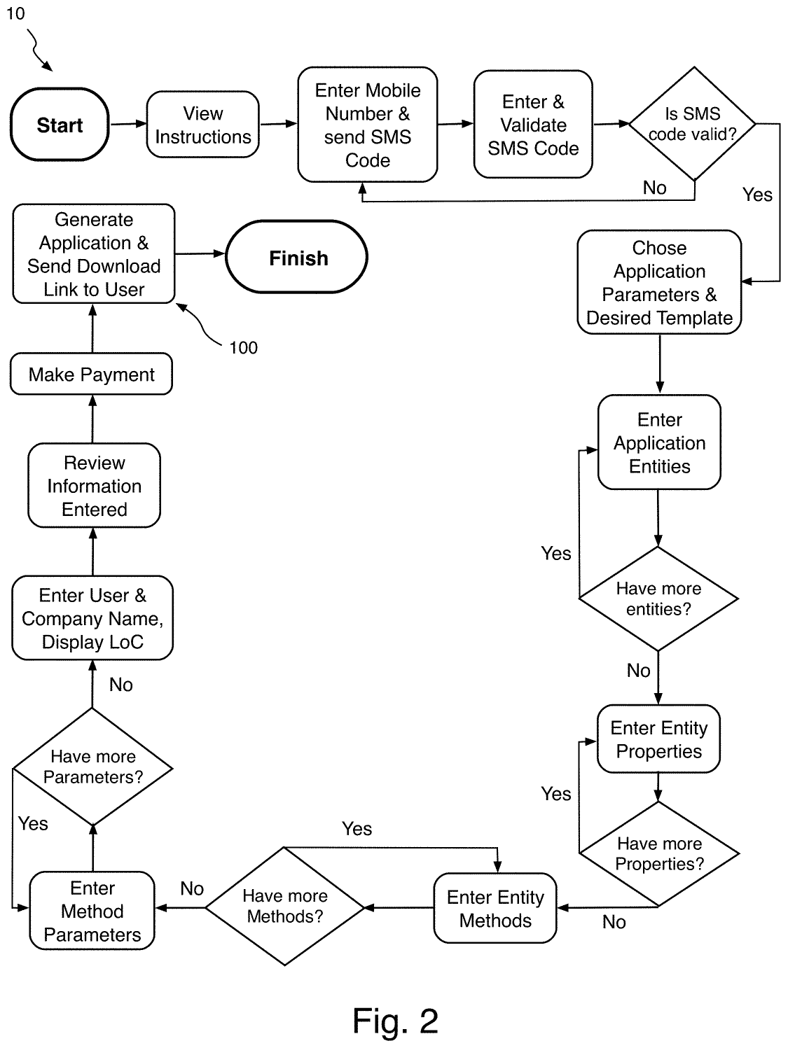

As seen in FIGS. 1 and 2, present invention 10 is a system and associated computer executable code generating software, comprising Wizard 30, whereby user 20 interacts with Wizard 30 to gather information 32. Wizard 30 is a piece of software that conducts a conversation via auditory or textual methods via and/or with a computer comprising a processor functionally associated with a digital memory.

Present invention 10 does not require that user 20 have programing knowledge, whereby when interacting with Wizard 30, present invention 10 generates application project 150. Wizard 30 may be published on a cloud computing service and offered as a service on the cloud service marketplace.

Present invention 10 generates web applications 152, mobile applications 154, and application programming interface applications 156 in different languages, and generates databases and queries in different technologies, whereby Wizard 30 interacts with a given user 20 to gather information 32 about a type of application project 150 that user 20 wants to develop in order for present invention 10 to generate it. User 20 views and reads instructions and questions 34 in a desired language that is provided through Wizard 30. Once ready, user 20 types a code of computer executable code generating software to start the process. In a preferred embodiment the code is defined as “devbot”.

User 20 enters a mobile number in order to get an SMS code to validate it. The SMS code is obtained with a computer such as a smart phone. If SMS code is not valid, user 20 repeats the operation, entering a mobile number again to get the SMS code. Once the SMS code is validated, user 20 chooses application parameters and a desired template. User 20 is prompted and starts to answer several questions 34, which the code utilizes to gather characteristics of application project 150 being generated.

In a preferred embodiment, Wizard 30 asks user 20 about a specific type of application project 150 that user 20 wants to generate, for example, a web application 152, mobile application 154, or application programming interface application 156. Wizard 30 asks user 20 which template(s) 50 are to be used. In addition, Wizard 30 requests information 32 about the kind of business entity it is dealing with. For example, user 20 may need to manage users, customers, and vendors within application project 150.

User 20 also enters application entities. Wizard 30 keeps asking if user 20 have more entities 52 to enter. Wizard 30 may also ask user 20 about each required entity's field(s) 54 or property(ies) 56, and their length. User 20 enters entity's property(ies) 56 such as their names and data types, and connects to a backend API. For example, entity(ies) 52 can have a property 56 called “FullName”, which can be alphanumeric with a length of 100 characters, and optionally require another property(ies) 56 called “Age” which can be integer. Wizard 30 keeps asking if user 20 has finished or not during the process of creating business entity(ies) 52 and field(s) 54 and property(ies) 56. These business entity(ies) 52 are posted to the backend API, which will store on a database for later reference.

When user 20 has finished to enter entity(ies) 52, field(s) 54 and property(ies) 56, user 20 enters entity methods and parameters. Wizard 30 keeps asking if user 20 has finished or not during the process of enters entity methods and parameters.

Code generation is achieved by reading entity(ies) 52 stored in a database and writing “C#”, a “MICROSOFT” programming language. In a preferred embodiment, code generation is achieved by reading the entity(ies) 52 stored in a database and writing Html (web) or Xml (mobile) files into preexisting project template(s) 50 adding more functionality to it. When a file is opened for reading or writing, it becomes a stream. The stream is basically the sequence of bytes passing through the communication path.

Once user 20 chooses the type of application project 150 is to generate, web application 152, mobile application 154, or application programming interface application 156, it will be copied from preexisting template(s) 50.

Template(s) 50 comprise all necessary files to be compiled and run from an integrated development environment (IDE). In a preferred embodiment, template(s) 50 may be for “MICROSOFT” web technology “ASP.NET”, “MICROSOFT” mobile technology “XAMARIN FORMS”, and for “MICROSOFT” API technology “WebAPI”. Preexisting template(s) 50 may be modified to include managing (insert, update, delete, list) business entity(ies) 52 selected. Preexisting template(s) 50 also have navigation capabilities to allow users 20 to choose which business entity(ies) 52 they want to work with. “MICROSOFT” technologies and others having similar characteristics will be targeted.

System and associated computer executable code generating software 10 generates cross-platform mobile applications built on a cross-platform mobile app development framework using “C#” language as a base for app development. Specifically, system and associated computer executable code generating software 10 generates cross-platform mobile applications for forms such as “XAMARIN FORMS”.

System and associated computer executable code generating software 10 generates cross-platform mobile applications build on a cross-platform mobile app development framework using a codebase of an object-oriented computer programming language to create interactive effects within web browsers. Specifically, system and associated computer executable code generating software 10 generates cross-platform mobile applications for open-source mobile application frameworks such as “REACT NATIVE”.

Present invention 10 helps developers to reuse only one language when targeting “ANDROID”/“iOS” and producing better and native user interface “UI” experiences, whereby “GOOGLE”'s “ANDROID” and “APPLE”'s “iOS” are operating systems used primarily in mobile technology, such as smartphones and tablets. There are Do It Yourself (DIY) tools on the web that only hybrid mobile apps base on web technology. Present invention 10 generates cross-platform mobile apps for forms such as “XAMARIN FORMS”.

Once entity(ies) 52 are entered, user 20 choses to execute automaton projector process 100, seen in FIG. 2. User 20 enters user name, and Company name to complete the information for records and payment purposes. A total of lines of code (LoC) is displayed to show user 20 the amount of code produced.

User 20 reviews all the information entered, and then user 20 is notified to make payment 90. More specifically, once user 20 has accepted terms and conditions, user 20 makes payment 90 for an application template fee and per each entity(ies) 52 created. This fee can be as low as $0.01 per line of code, saving user 20 potentially hundreds or thousands of dollars on programming labor. When payment 90 is made, the application is generated and user 20 receives an email having a link to download at a computer such as a smartphone or tablet the generated application project 150, which is web application 152, mobile application 154, or application programming interface application 156.

Computer executable code generating software of present invention 10 generates clean and easy-to-use code for any developer familiar with a language selected. It will also implement common programming good practices to help developers to follow quality standards. “MICROSOFT” programming languages “C#” and “T-SQL” may be produced in a first product iteration. Generally accepted programming good practices and field validation will be included as part of the code generated by present invention 10. For example: the “C#” pattern will be implemented where application project to dispose/destroy variables after they have been used. Also, data entry form fields may be validated when user 20 had specified a field(s) 54 or property(ies) 56 as required. Error handling will be included to capture database or field validation exceptions. These may be shown to the application user as feedback.

Database code generation of present invention 10 is achieved by reading entity(ies) 52 in a database and writing script files to disk. These files are later run by user 20 to create it in a database server. “C#” code generation is achieved by reading entity(ies) 52 stored in the database and writing “C#” files into a preexisting web or mobile project template(s) 50 adding more functionality to it.

Computer executable code generating software of present invention 10 will be hosted and published as a service where users 20 can subscribe to it to generate their application projects 150. Programs that exist today are licensed where a user may need to upgrade when there are changes. Users 20 will benefit from getting the latest updates every time they use said programs. Every time code is updated (app templates, API, database, etc.) it may be published. Therefore, users 20 may obtain the latest version of code available.

Computer executable code generating software of present invention 10 may stay up-to-date with technology. It will evolve as technology changes. An example of this already is by integrating artificial intelligence or intelligent user interface, specifically Wizard 30, into present invention 10.

In a preferred embodiment, Wizard 30 is an intelligent user interface that may interacts with user 20 through a web application, a mobile application, a Chatbot, voice commands, or any other smart command without limitation.

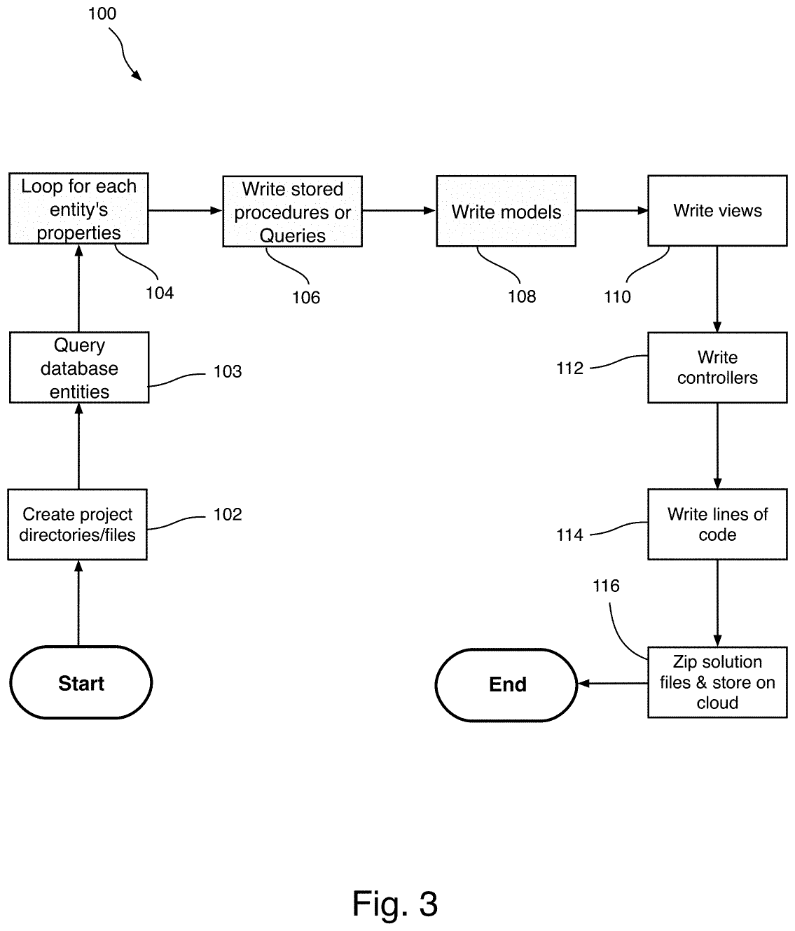

As seen in FIGS. 1, 2, and 3, automaton projector process 100 is a process where data already entered by user 20 is queried on a database and application project 150 is generated.

First, a project's directory, dependencies, and core files are created at step 102 and then query database entities at step 103. Then entities are read from a database while looping through their properties at step 104. This loop gets each entity property a characteristic such as if its an integer or an alphanumeric field, if it is null or not null, its field length, etc. While each entity and its properties are being read, stored procedures or queries are generated for entity processing in the database. Then model classes are generated including their properties and method at step 108, whereby this method calls the stored procedures previously generated at step 106. Then views are generated for listing entities of the same type as well as to data entry each entity details at step 110. With each entity property characteristics, fields are generated according its type and validated where applicable. Then controller classes are generated to handle application routing connecting model classes at step 112 with view generated in previous step 110. After all necessary files have been generated, a total lines of code are totalized at step 114 to show user 20 how much code has been produced and the potential man-hours and estimated dollar amount saved. With these totals/results, file application project 150 is completed, zipped on a compressed file, and stored in a cloud-protected storage at step 116. Once user 20 processes a payment, user 20 is able to download application project 150 generated for which user 20 will receive an email with a link at the computer such as a smartphone or tablet.

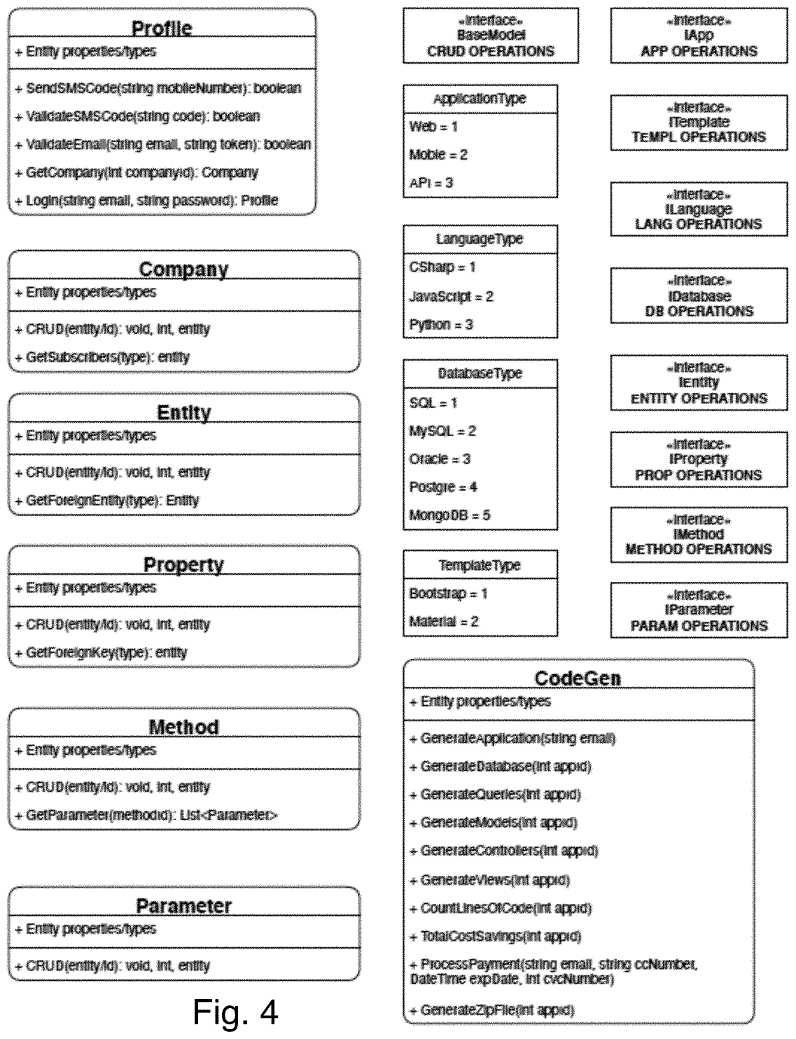

As seen in FIG. 4, it is described the algorithms, interfaces, and codes used in present invention 10 in connection to subscriber or user 20, Company, entity(ies) 52, property(ies) 56, methods, and parameters regarding entities 52.

Application types may be web application 152, mobile application 154, and API application 156.

Languages types may be CSharp, JavaScript, and Phython.

Data base types may be SQL, MySQL, Oracle, Postgre, and MongoDB.

Template types may be Bootstrap and Material.

Interfaces are comprised by BaseModel CRUD OPERATIONS, BaseApp APP OPERATIONS, BaseTemplate TEMPL OPERATIONS, BaseEntity ENTITY OPERATIONS, BaseProperty PROP OPERATIONS, BaseMethod METHOD OPERATIONS, and BaseParameter PARAM OPERATIONS.

CodeGen comprises:
+Entity properties/types
+GenerateApplication(string email)
+GenerateDatabase(int appId)
+GenerateQueries(int appId)
+GenerateModels(int appId)
+GenerateControllers(int appId)
+GenerateViews(int appId)
+CountLinesOfCode(int appId)
+TotalCostSavings(int appId)
+ProcessPayment(string email, string ccNumber, DateTime expDate, int cvcNumber)
+GenerateZipFile(int appId)

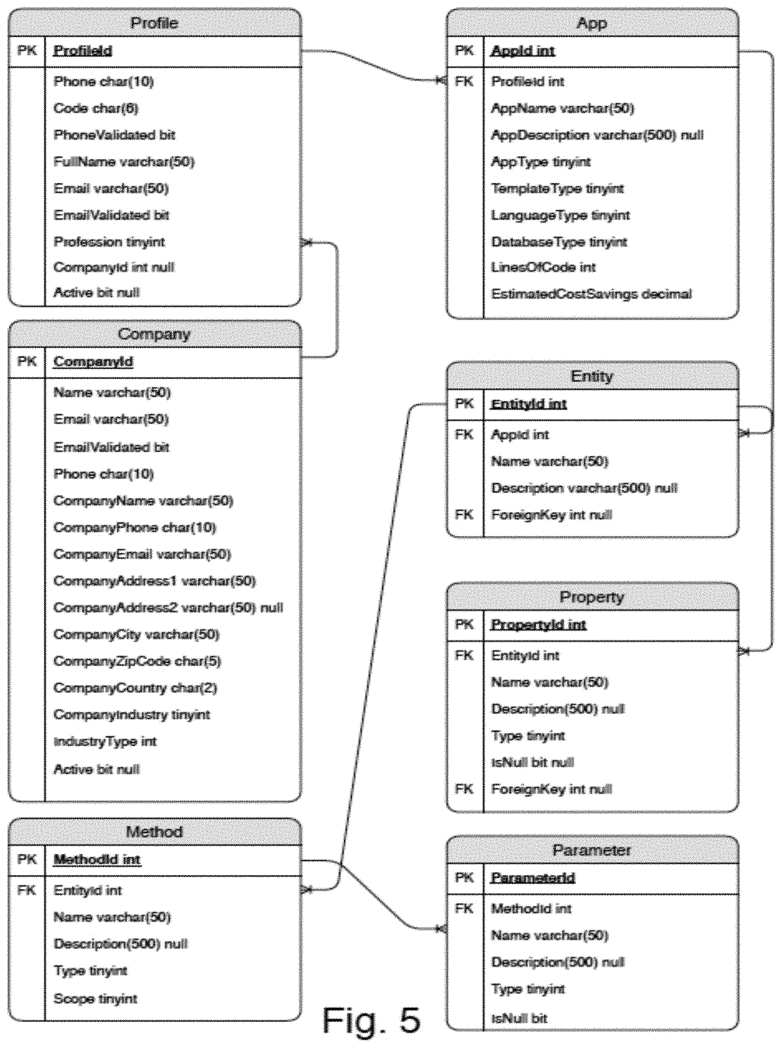

As seen in FIG. 5, it is represented a relational database. Profile table has a unique identifier named ProfileId. Profile table links to App table. Profile table comprises the following columns:
Phone—char(10)
Code—char(6)
PhoneValidated—bit
FullName—varchar(50)
Email—varchar(50)
EmailValidated—bit
Profession—tinyint
CompanyId—int null
Active—bit null

App table has a unique identifier named AppId and foreign key that refers to profileId in the profile table. App table comprises the following columns:
AppName—varchar(50)
AppDescription—varchar(500) null
AppType—tinyint
TemplateType—tinyint
LanguageType—tinyint
DatabaseType—tinyint
LinesOfCode—int
EstimatedCostSavings—decimal

Property table has a unique identifier named PropertyId and a foreign key that refers to entityId in the entity table. Property table comprises the following columns:
Name—varchar(50)
Description—(500) null
Type—tinyint
IsNull—bit null

Company table links with Profile table. Company table has a unique identifier named CompanyId. Company table comprises the following columns:
Name—varchar(50)
Email—varchar(50)
EmailValidated—bit
Phone—char(10)
CompanyName—varchar(50)
CompanyPhone—char(10)
CompanyEmail—varchar(50)
CompanyAddress1—varchar(50)
CompanyAddress2—varchar(50) null
CompanyCity varchar(50)
CompanyZipCode—char(5)
CompanyCountry—char(2)
CompanyIndustry—tinyint
IndustryType—int
Active—bit null

Entity table has a unique identifier named EntityId and a foreign key that refers to AppId in the App table. Entity table links with Method table. Entity table comprises the following columns:
Name—varchar(50)
Description—varchar(500) null

Method table comprises a unique identified named MethodId and a foreign key that refers to EntityId in the Entity table. Method table links with Parameter table. Method table comprises the following columns:
Name—varchar(50)
Description—(500) null
Type—tinyint
Scope—tinyint

Parameter table comprises a unique identified named ParameterId and a foreign key that refers to methodId in the Method table. Parameter table comprises the following columns:
Name—varchar(50)
Description—(500) null
Type—tinyint
IsNull—bit

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A system and associated computer executable code generating software, comprising:
A) a processor functionally associated with a digital memory, said digital memory stores processor executable code adapted to cause one or more processors to:
(i) analyze code instructions of a Wizard to automatically generate web applications, mobile applications, and application programming interface applications.

2. The system and associated computer executable code generating software set forth in claim 1, wherein a user interacts with said Wizard to gather information and said Wizard is a piece of software that conducts a conversation via auditory or textual methods via and/or with a computer comprising a processor functionally associated with a digital memory.

3. The system and associated computer executable code generating software set forth in claim 2, wherein said executable code generates an application project.

4. The system and associated computer executable code generating software set forth in claim 3, wherein said executable code generates said web applications, said mobile applications, and said application programming interface applications in different languages, and generates databases and queries in different technologies, whereby said Wizard interacts with a given said user to gather information about a type of said application project that said user wants to develop.

5. The system and associated computer executable code generating software set forth in claim 2, wherein said user views and reads instructions and questions in a desired language that is provided through said Wizard.

6. The system and associated computer executable code generating software set forth in claim 2, wherein said user enters a mobile number in order to get an SMS code to validate it, whereby said SMS code is obtained with a computer such as a smart phone.

7. The system and associated computer executable code generating software set forth in claim 6, wherein once said SMS code is validated, said user is prompted and starts to answer several questions, which said code utilizes to gather characteristics of said application project.

8. The system and associated computer executable code generating software set forth in claim 4, wherein said Wizard asks said user about each required entity's fields or properties, and their length, and said user enters said entity's properties such as their names and data types, and connects to a backend Application Programing Interphase.

9. The system and associated computer executable code generating software set forth in claim 8, wherein said Wizard keeps asking if said user has finished or not during the process of creating business entities, said field and said properties, and said business entities are posted to said backend Application Programing Interphase, which will store on said database.

10. The system and associated computer executable code generating software set forth in claim 9, wherein said code generation is achieved by reading said entities stored in said database and writing programming language files into a preexisting Application Programing Interphase project.

11. The system and associated computer executable code generating software set forth in claim 10, wherein said code generation is achieved by reading said entities stored in said database and writing Html or Xml files into preexisting project templates, and when a file is opened for reading or writing, said file becomes a stream, said stream is a sequence of bytes passing through the communication path.

12. The system and associated computer executable code generating software set forth in claim 11, whereby once said user chooses a type of said application project to generate, said web application, said mobile application, or said application programming interface application, it is copied from said templates.

13. The system and associated computer executable code generating software set forth in claim 12, wherein said templates comprise all necessary files to be compiled and run from an integrated development environment, and said templates are modified to include managing said business entities selected, said templates also have navigation capabilities to allow said users to choose which of said business entities they want to work with.

14. The system and associated computer executable code generating software set forth in claim 13, wherein said system and associated computer executable code generating software generates cross-platform mobile applications built on a cross-platform mobile app development framework language as a base for app development.

15. The system and associated computer executable code generating software set forth in claim 14, wherein said system and associated computer executable code generating software generates said cross-platform mobile applications build on said cross-platform mobile app development framework using a codebase of an object-oriented computer programming language.

16. The system and associated computer executable code generating software set forth in claim 15, wherein once said entities are entered, said user choses to execute automaton projector process.

17. The system and associated computer executable code generating software set forth in claim 16, wherein said user is notified to make payment according the lines of code generated, when said payment is made, said user receives an email having a link with said application project generated.

18. The system and associated computer executable code generating software set forth in claim 17, whereby data entry form fields are validated when said user specifies said fields or said properties.

19. The system and associated computer executable code generating software set forth in claim 18, whereby said database code generation is achieved by reading said entities in said database and writing script files to disk.

20. The system and associated computer executable code generating software set forth in claim 19, whereby said files are later run by said user to create it in a database server.
